(19) United States
(12) Patent Application Publication
(10) Pub. No.: US 2013/0117471 A1
(43) Pub. Date: May 9, 2013

(54) CONFIGURATION OF A METROLOGICALLY SEALED DEVICE VIA A PASSIVE RF INTERFACE

(71) Applicant: Philip Ouellette, Columbus, OH (US)

(72) Inventor: Philip Ouellette, Columbus, OH (US)

(73) Assignee: METTLER-TOLEDO, INC., Columbus, OH (US)

(21) Appl. No.: 13/291,880

(22) Filed: Nov. 8, 2011

(51) Int. Cl. G06F 3/00

(52) U.S. Cl. 710/13

(57) ABSTRACT

Systems and methods that allow for the configuration or reconfiguration of an electronic metrologic device without having to handle the device or open the device packaging. Configuration/reconfiguration is accomplished by way of passive RF communication between a RF read/write device and a RF-enabled memory device installed to the metrologic device. Processing of configuration changes is handled in accordance with legal-for-trade requirements.

### TECHNICAL FIELD

The present invention is directed to the configuration of a metrologically sealed metrologic device by RF means.

### BACKGROUND

Generally, metrologic devices are at least metrologically sealed after manufacture to ensure that the metrologic function thereof remains accurate and cannot be tampered with. This is particularly true when a metrologic device will be used in a legal-for-trade setting. Metrologic sealing may be accomplished in a number of ways, such as by sealing the entire enclosure or housing of a device or sealing only a compartment or section of the device containing metrologic-specific components.

Once a metrologically-sealed device is manufactured and configured, it is often placed into packaging or into some other type of shipping container in which it will travel to its end destination. While a given electronic metrologic device may be designed for a specific purpose, particular functions, operations and other features of such a device may often be specifically configured to meet customer preferences or requirements.

If an electronic metrologic device is not configured to meet such customer preferences or requirements during the manufacturing stage, such a device may often be reconfigured in the proper manner afterwards. Typically, such a procedure would involve removing the device from its packaging or shipping container and connecting the device to a power source and a computer (e.g., PC) that is used to perform the reconfiguration operation. One problem associated with after-manufacture metrologic device reconfiguration is that metrologically-sealed devices require special handling during configuration in order to maintain legal-for-trade approval, and not all persons attempting such a reconfiguration will have the requisite knowledge or skill to perform the procedure while maintaining the legal-for-trade integrity of the device.

Therefore, it would be both desirable and advantageous to provide a system and method for configuring or reconfiguring a metrologically-sealed electronic metrologic device without having to handle or contact the device and without having to open or remove the device from its packaging or other shipping container if the device already resides therein. The present invention is such a system and method.

### SUMMARY

Embodiments of the present invention allow for the configuration or reconfiguration (hereinafter simply configuration) of a metrologically-sealed electronic metrologic device at a location, such as a shipping location, without having to handle the device or open the device packaging. The inventive configuration process meets legal-for-trade requirements for device configuration while the device remains sealed in its shipping packaging. This procedure avoids the expense of unpacking and repacking the device from its packaging and also avoids the risk of accidental damage that might occur if the device is removed from its shipping packaging.

RF-enabled memory devices are now available that can use passive RF technology to wirelessly read and write the memory device even though the device in which the RF-enabled memory device is installed is not connected to a power source. Examples of RF-enabled memory devices that may be used for this purpose include but are not limited to the M24LR16E-R and M24LR64-R RF-enabled memory devices available from STMicroelectronics, which is headquartered in Geneva, Switzerland. As described below, embodiments of the invention employ such RF-enabled memory devices to configure a metrologically-sealed electronic metrologic device without having to handle the metrologic device or open the metrologic device packaging.

Configurable electronic metrologic devices normally contain one or more non-volatile memory devices that are connected to the microprocessor of the metrologic device. One memory device (or portion of a single memory device) is typically used to store the operating configuration parameters of the metrologic device. This memory device may be referred to as the Configuration EEPROM. Normally, the contents of the Configuration EEPROM can only be modified by the metrologic device microprocessor under program control and following specific legal-for-trade procedures. Thus, the Configuration EEPROM can only be modified when the metrologic device is connected to an electric power source (e.g., an AC outlet, batteries, etc.).

In embodiments of the invention, a second memory device (or other portion of a single memory device) is RF-enabled and is used to store configuration change requests. This memory device may be referred to as the RF-Enabled EEPROM. Configuration change requests are loaded into the RF-Enabled EEPROM during manufacture or after manufacture at a location such as a logistics distribution hub or other facility, but before receipt of the metrologic device by a customer and without the need to connect the metrologic device to a power source. The RF-Enabled EEPROM may contain device identification data (e.g., model number and serial number) that permits systems employed in the RF-based configuration operation to identify the metrologic device and to optionally track changes made thereto. The RF-enabled EEPROM may also contain a copy of the configuration data stored in the Configuration EEPROM to permit the RF-based configuration system to read the current configuration data from the device.

When the configurable electronic metrologic device is subsequently powered up, the configuration parameters stored by the RF-enabled memory device are written to the configuration memory device such that the metrologic device will thereafter operate using the newly written configuration parameters. Prior to writing the stored configuration parameters to the configuration memory device, the device may check a configuration setting in the Configuration EEPROM to determine if RF-based configuration is permitted. In such an embodiment, the configuration parameters stored by the RF-enabled memory device are written to the configuration memory device only if RF-based configuration is determined to be permitted. In any case, configuration change requests are carried out in a manner that satisfies legal-for-trade requirements for metrologically sealed devices.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 schematically illustrates a metrologically-sealed, configurable electronic metrologic device, residing in sealed packaging and located within range of a RF read/write system; and

FIG. 2 is a flow chart detailing the steps associated with configuring such a configurable electronic metrologic device according to one exemplary embodiment of the invention, without removing the metrologic device from its packaging or connecting the metrologic device to an electric power source.

### DETAILED DESCRIPTION OF EXEMPLARY EMBODIMENT(S)

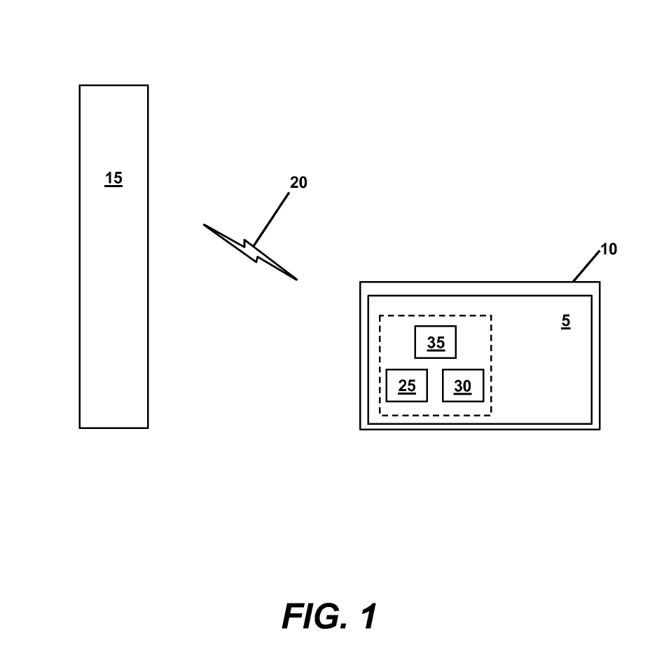

FIG. 1 schematically represents an exemplary configurable and metrologically-sealed electronic metrologic device 5 (hereinafter “metrologic device” for brevity) residing in sealed packaging 10 such as a shipping container, which is shown in transparency for clarity of observation and explanation. The packaged metrologic device 5 resides within communication range of a RF read/write system 15 that may be used to extract information from the metrologic device and write information to metrologic device, as is indicated by the arrow 20, while the metrologic device remains in sealed packaging 10. The RF read/write system 15 may be placed in any of various locations at which a metrologic device will also be at least temporarily located prior to shipment to a customer. One non-limiting example of such a location is a distribution hub through which the metrologic device will pass on its way to a customer. Such RF read/write systems would be well known to those of ordinary skill in the art and, therefore, need not be described in further detail herein.

As described above, the metrologic device 5 is shown to include a Configuration EEPROM 25 and a RF-Enabled EEPROM 30, which are shown in FIG. 1 as separate memory devices but which may also be portion of a single memory device. The Configuration EEPROM 25 is used to store the operating configuration parameters of the metrologic device 5. The contents of the Configuration EEPROM 25 can only be modified by the metrologic device microprocessor 35 under program control and following specific legal-for-trade procedures. Thus, the Configuration EEPROM can only be modified when the metrologic device is connected to an electric power source (e.g., AC power, batteries, etc.).

The RF-Enabled EEPROM 30 is used to store configuration change requests, which may loaded into the RF-Enabled EEPROM during manufacture, or at the location of the RF read/write system 15 via RF communication between the RF read/write system and the RF-Enabled EEPROM. The RF-Enabled EEPROM 30 preferably contains device identification data (e.g., model number and serial number) that permits the RF read/write system 15 to identify the metrologic device 5 and to optionally track changes made thereto. The RF-enabled EEPROM 30 may also contain a copy of the configuration data stored in the Configuration EEPROM 25 to permit the RF read/write system 15 to read the current configuration data from the metrologic device 5.

The programming of a wide variety of configuration requests is possible according to the invention. For example, an exemplary and non-limiting list of such configuration requests may include: set metrological password (required before any metrologically locked sections can be changed); set service password (required before any service locked selections can be changed); set weight units; configure build data, capacity, increment size, etc.; set zero capture limits; set unit switching mode; set center of zero display mode; set GEO location code; and/or other functionality that is supported by the device. The full range of possible configuration requests is more extensive, and possible requests will likely depend at least in part on the specific nature of the metrologic device.

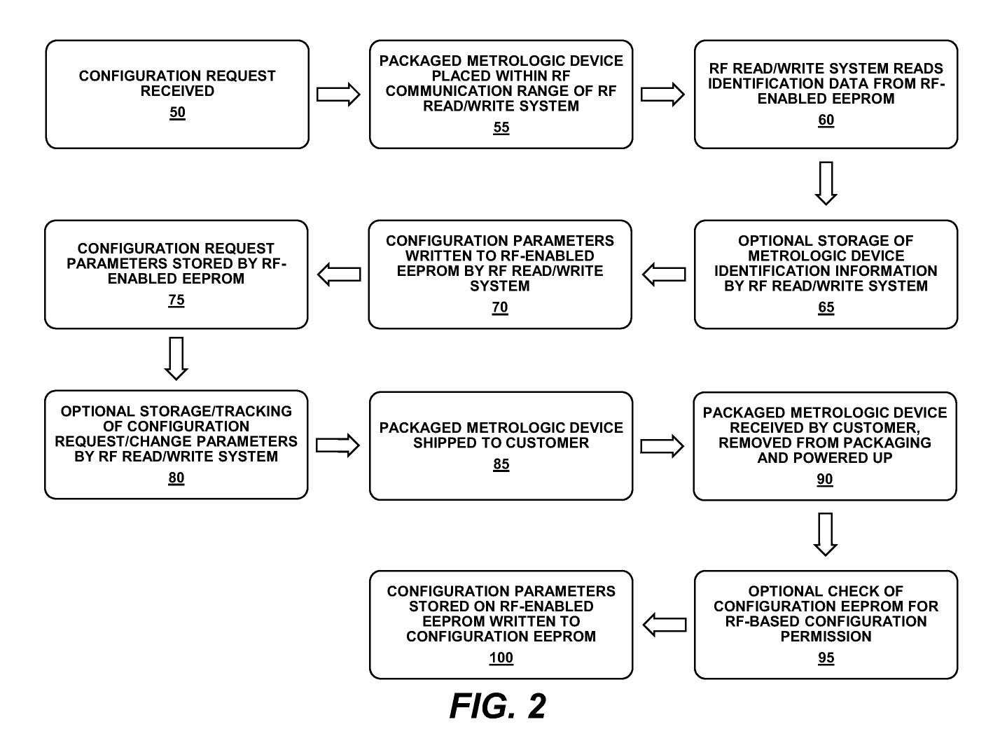

Referring now to FIG. 2, the steps associated with performing one exemplary RF-based metrologic device configuration operation according to the invention can be observed. As an initial part of the overall process, a customer will have ordered a particular metrologic device from a source for the metrologic device. As shown and described in FIG. 2 and in FIG. 1, the metrologic device 5 is in transit to the customer and, in this particular case, is located at a logistics distribution hub. The logistics distribution hub includes the RF read/write system 15 that is adapted to communicate with the RF-enabled EEPROM of the metrologic device 5.

At some point in the process, a metrologic device configuration request is received directly or indirectly from the customer 50 or a representative of the customer. For purposes of this example, it can be assumed that the configuration request was received after manufacture of the metrologic device was complete and, therefore the metrologic device was packaged and shipping to the customer was initiated without the requested configuration parameters being installed.

In order to program the metrologic device with the requested configuration parameters, the packaged metrologic device is placed within RF communication range of the RF read/write system 55. The RF read/write system then reads metrologic device identification data that resides on the RF-Enabled EEPROM 60. Once the metrologic device identification data is read, the RF read/write system may optionally store the data locally or remotely for subsequent tracking and/or other purposes 65.

Once the RF read/write system has identified the metrologic device and insured that the configuration request parameters at hand are intended for the identified metrologic device, the RF read/write system proceeds, via RF communication, to write the requested configuration parameters to the RF-Enabled EEEPROM 70. The configuration request parameters are then stored by the RF-Enabled EEPROM 75 for later retrieval. As with the metrologic device identification data, the RF read/write system may also optionally store/track the configuration request parameters written to the RF-enabled EEPROM of a given metrologic device 80.

With the metrologic device reconfigured with the configuration request parameters, the still-packaged metrologic device is shipped to the customer 85, where it is subsequently removed from its packaging and powered up 90. In certain embodiments, the metrologic device may automatically check a configuration setting in the Configuration EEPROM upon power-up to determine if RF-based configuration is permitted for the given metrologic device 95. In other embodiments, no such check is conducted. If RF-based configuration is determined to be permitted, or if no check of such a configuration setting is conducted, the configuration parameters stored in the RF-Enabled EEPROM are treated as operator requests (as though they had been entered via the user interface or host interface of the device) and are subject to any legal-for-trade rules regarding device configuration. Configuration change requests that meet legal-for-trade requirements are then written to the Configuration EEPROM 100 by the microprocessor of the metrologic device such that the metrologic device will operate using the new configuration parameters.

Password protection may be added to provide additional security to the RF-based configuration process. For example, a change request to set a password would need to be processed before any password protected parameters will be changed. A change request to a password protected parameter would then be discarded if the required password has not been previously set.

A metrologic device configured according to the present invention may perform a number of operations subsequent to writing the new configuration parameters to the Configuration EEPROM. Such exemplary operations may include, for example and without limitation, clearing the RF Configuration permission setting in the Configuration EEPROM 150. The metrologic device may also increment a configuration access counter value stored in the Configuration EEPROM and/or erase the contents of the RF-Enabled EEPROM.

Therefore, it can be understood from the foregoing description that a metrologic device may be configured according to the invention such that the metrologic device will have the requested configuration parameters loaded therein at first use. This may be accomplished according to the invention without handling the metrologic device, without removing the metrologic device from its packaging, without connecting the metrologic device to a power source, and with the legal-for-trade status of the metrologic device still intact. With respect to the legal-for-trade status of a metrologic device it is noted that, if necessary to fulfill legal-for-trade traceability and audit requirements, a RF read/write system can be provided with the ability to record all configuration requests loaded into the RF-Enabled EEPROM of a metrologic device along with device identifying information such as the device model and serial number.

While certain embodiments of the present invention are described in detail above, the scope of the invention is not to be considered limited by such disclosure, and modifications are possible without departing from the spirit of the invention as evidenced by the following claims:

What is claimed is:

1. A method of configuring an electronic metrologic device via a passive RF interface, comprising:
providing an electronic metrologic device with a RF-enabled memory device, the RF-enabled memory device in communication with a microprocessor and a configuration memory device of the metrologic device;
passively writing configuration parameters to the RF-enabled memory device using a RF read/write device while the metrologic device is in a non-powered state, the configuration parameters stored by the RF-enabled memory device; and
upon power-up of the metrologic device, writing the configuration parameters stored by the RF-enabled memory device to the configuration memory device such that the metrologic device will thereafter operate using the newly written configuration parameters.

2. The method of claim 1, wherein configuration of the metrologic device occurs while the metrologic device resides within sealed packaging.

3. The method of claim 1, wherein the RF-enabled memory device and the configuration memory device are EEPROM devices.

4. The method of claim 1, wherein the RF read/write device reads identification data stored on the RF-enabled memory device to identify the metrologic device prior to writing configuration parameters thereto.

5. The method of claim 4, further comprising storing identification data associated with a given metrologic device to be configured.

6. The method of claim 1, further comprising tracking configuration changes made to a configured metrologic device.

7. The method of claim 1, wherein upon power-up of the metrologic device, the metrologic device performs one or more operations selected from the group consisting of clearing the RF-based configuration permission setting in the configuration memory device, incrementing a configuration access counter value stored in the configuration memory device, and erasing the contents of the RF-Enabled memory device.

8. The method of claim 1, wherein the configuration parameters include one or more of the group consisting of set metrological password, set service password, set weight units, configure build data, configure capacity, configure increment size, set zero capture limits, set unit switching mode, set center of zero display mode, and set GEO location code.

9. The method of claim 1, wherein the metrologic device is a metrologically-sealed electronic metrologic device.

10. The method of claim 1, wherein the metrologic device is a legal-for-trade device.

11. The method of claim 1, further comprising causing the microprocessor to check a RF-based configuration permission setting programmed in the configuration memory device to determine if RF-based configuration of the metrologic device is permitted prior to writing the configuration parameters stored by the RF-enabled memory device to the configuration memory device.

12. A method of configuring a metrologically-sealed electronic metrologic device via a passive RF interface, comprising:
providing an electronic metrologic device with a RF-enabled memory device, the RF-enabled memory device including stored metrologic device identification data, the RF-enabled memory device in communication with a microprocessor and a configuration memory device of the metrologic device;
using a RF read/write device to read the identification data stored on the RF-enabled memory device;
passively writing configuration parameters to the RF-enabled memory device using the RF read/write device while the metrologic device is in a non-powered state, the configuration parameters stored by the RF-enabled memory device; and
upon power-up of the metrologic device, writing the configuration parameters stored by the RF-enabled memory device to the configuration memory device such that the metrologic device will thereafter operate using the newly written configuration parameters.

13. The method of claim 12, wherein configuration of the metrologic device occurs while the metrologic device resides within sealed packaging.

14. The method of claim 12, wherein the RF-enabled memory device and the configuration memory device are EEPROM devices.

15. The method of claim 12, further comprising storing identification data associated with a given metrologic device to be configured.

16. The method of claim 12, further comprising tracking configuration changes made to a configured metrologic device.

17. The method of claim 12, wherein upon power-up of the metrologic device, the metrologic device performs one or more operations selected from the group consisting of clearing the RF-based configuration permission setting in the configuration memory device, incrementing a configuration access counter value stored in the configuration memory device, and erasing the contents of the RF-Enabled memory device.

18. The method of claim 12, wherein the configuration parameters include one or more of the group consisting of set metrological password, set service password, set weight units, configure build data, configure capacity, configure increment size, set zero capture limits, set unit switching mode, set center of zero display mode, and set GEO location code.

19. The method of claim 12, further comprising causing the microprocessor to check a RF-based configuration permission setting programmed in the configuration memory device to determine if RF-based configuration of the metrologic device is permitted prior to writing the configuration parameters stored by the RF-enabled memory device to the configuration memory device.

20. A method of configuring a metrologically-sealed electronic metrologic device via a passive RF interface while the metrologic device resides within sealed packaging, comprising:
providing an electronic metrologic device with a RF-enabled memory device, the RF-enabled memory device including stored metrologic device identification data, the RF-enabled memory device in communication with a microprocessor and a configuration memory device of the metrologic device;
using a RF read/write device to read the identification data stored on the RF-enabled memory device;
storing identification data associated with a given metrologic device to be configured;
tracking configuration changes made to a configured metrologic device;
passively writing configuration parameters to the RF-enabled memory device using the RF read/write device while the metrologic device is in a non-powered state, the configuration parameters stored by the RF-enabled memory device; and
upon power-up of the metrologic device, writing the configuration parameters stored by the RF-enabled memory device to the configuration memory device such that the metrologic device will thereafter operate using the newly written configuration parameters.

21. The method of claim 20, wherein upon power-up of the metrologic device, the metrologic device performs one or more operations selected from the group consisting of clearing the RF-based configuration permission setting in the configuration memory device, incrementing a configuration access counter value stored in the configuration memory device, and erasing the contents of the RF-Enabled memory device.

22. The method of claim 20, wherein the configuration parameters include one or more of the group consisting of set metrological password, set service password, set weight units, configure build data, configure capacity, configure increment size, set zero capture limits, set unit switching mode, set center of zero display mode, and set GEO location code.

23. The method of claim 20, further comprising causing the microprocessor to check a RF-based configuration permission setting programmed in the configuration memory device to determine if RF-based configuration of the metrologic device is permitted prior to writing the configuration parameters stored by the RF-enabled memory device to the configuration memory device.
